(19) United States
(12) Patent Application Publication
(10) Pub. No.: US 2025/0074580 A1
(43) Pub. Date: Mar. 6, 2025

(54) AIRCRAFT COMPRISING AT LEAST ONE CAVITY OPENING AT AN AERODYNAMIC WALL AND PROVIDED WITH A PARTIAL REDUCTION IN PASSAGE SECTION

(71) Applicant: Airbus Operations SAS, TOULOUSE (FR)

(72) Inventors: Thierry FARGIER, TOULOUSE (FR); Maria Del Sagrario JUANAS FERNANDEZ, TOULOUSE (FR); Thomas NODE-LANGLOIS, TOULOUSE (FR); Stéphane GALDEANO, TOULOUSE (FR); Jean-Paul ROMEO, TOULOUSE (FR)

(21) Appl. No.: 18/814,698

(22) Filed: Aug. 26, 2024

(30) Foreign Application Priority Data
Aug. 28, 2023 (FR) 2309021

(51) Int. Cl. B64D 33/00

(52) U.S. Cl. CPC B64C 23/00; B64C 2230/08; B64C 2230/14

(57) ABSTRACT

An aircraft including at least one aerodynamic wall against which an airflow flows in a direction of flow when the aircraft is in flight and at least one cavity opening at the aerodynamic wall, the cavity being delimited by a tubular lateral wall and a bottom. The cavity comprises at least one reduction in passage section spaced apart from the bottom and extending only over a part of the circumference of the tubular lateral wall.

### CROSS-REFERENCES TO RELATED APPLICATIONS

This application claims the benefit of French Patent Application Number 2309021 filed on Aug. 28, 2023, the entire disclosure of which is incorporated herein by way of reference.

### FIELD OF THE INVENTION

The present application relates to an aircraft comprising at least one cavity opening at an aerodynamic wall and provided with a partial reduction in passage section.

### BACKGROUND OF THE INVENTION

According to one embodiment, an aircraft 10 comprises a fuselage 12, wings 14 provided on either side of the fuselage 12, and propulsion assemblies 16 connected to the wings by pylons 18. The aircraft 10 comprises at least one air intake device 20, visible in FIG. 2, which opens at an aerodynamic wall 22 in contact with an airflow 24 when the aircraft 10 is in flight. This air intake device 20 is configured to capture a part of the airflow 24 and convey it in the direction of an item of equipment of the aircraft. The aerodynamic wall 22 may be provided at the fuselage 12, at a wing 14, at a propulsion assembly 16 or at a pylon 18.

According to one configuration, the air intake device 20 comprises an intake duct 26, which extends between a first end 26.1 connected to the aerodynamic wall 22 and a second end 26.2, and a valve 28 connected to the second end 26.2 of the intake duct 26 and configured to occupy a permissive state in which the valve 28 allows an airflow channeled by the intake duct 26 to pass through it and a closed state in which the valve 28 blocks the airflow in the intake duct 26.

According to one configuration, the first end 26.1, which opens at the aerodynamic wall 22, is flared and forms an air inlet of the flush type. According to this configuration, the first end 26.1 of the intake duct 26 is positioned on a reference surface substantially parallel to the airflow 24, the reference surface being, apart from the intake duct 26, coincident with the outer face of the aerodynamic wall 22 in contact with the airflow 24.

The air intake device 20 is optimized so as to reduce the drag of the aircraft when the valve 28 is in the open state.

When the valve 28 is in the closed state, the intake duct 26 and the valve 28 in the closed state form a cavity 30, shown schematically in FIG. 3, which opens at the aerodynamic wall 22. The airflow 24 that flows over the cavity 30 generates aerodynamic noise, in particular whistling, because of the coupling between a return airflow 24.1 formed in the cavity 30 and a disturbed flow 24.2 that appears after the upstream edge 30.1 of the cavity 30.

### SUMMARY OF THE INVENTION

The present invention aims to remedy all or some of the drawbacks of the prior art.

To this end, a subject of the invention is an aircraft comprising at least one aerodynamic wall against which an airflow flows in a direction of flow when the aircraft is in flight and at least one cavity opening at the aerodynamic wall, the cavity being delimited by a tubular lateral wall that extends between first and second ends and a bottom spaced apart from the aerodynamic wall and situated at the second end of the tubular lateral wall, the first end of the tubular lateral wall being situated at the aerodynamic wall, the cavity having a reference passage section and a depth, the tubular lateral wall being parallel to a reference direction and having a circumference.

According to the invention, the cavity comprises at least one reduction in passage section, spaced apart from the bottom, which extends only over a part of the circumference of the tubular lateral wall.

The fact that the reduction in passage section is spaced apart from the bottom and partial (not continuous over the entire circumference of the tubular lateral wall) makes it possible to obtain a reduction in aerodynamic noise.

According to another feature, the reduction in passage section extends over half the circumference of the tubular lateral wall with a tolerance interval of +/−20%, preferably of +/−5%.

According to another feature, the reduction in passage section is positioned in an upstream half-space delimited by a median plane perpendicular to the direction of flow of the airflow.

According to another feature, the reduction in passage section is positioned in a transverse plane perpendicular to the reference direction.

According to another feature, the transverse plane is situated at a distance from the bottom of the order of 30% of the depth of the cavity with a tolerance interval of +/−20%, preferably of +/−5%.

According to another feature, the reduction in passage section has a passage section of the order of 80% of the reference passage section with a tolerance interval of the order of +/−10%, preferably of +/−5%.

According to another feature, the tubular lateral wall is cylindrical and has a reference diameter. In addition, the reduction in passage section has a diameter of the order of 80% of the reference diameter with a tolerance interval of the order of +/−10%, preferably of +/−5%.

According to another feature, the reduction in passage section comprises a rib, projecting with respect to the tubular lateral wall, having a first edge face that extends from the tubular lateral wall, oriented toward the first end of the tubular lateral wall, and a second edge face that extends from the tubular lateral wall, oriented toward the bottom.

According to another feature, the first edge face forms an angle with the tubular lateral wall of between 20 and 60°, preferably of between 30 and 40°.

According to another feature, the second edge face is substantially perpendicular to the tubular lateral wall.

According to another characteristic, the rib is a hollow roll attached against the tubular lateral wall.

According to another feature, the aircraft comprises an air intake device having an intake duct, which extends between a first end connected to the aerodynamic wall and a second end, and a valve connected to the second end of the intake duct and configured to occupy a permissive state in which the valve allows an airflow channeled by the intake duct to pass through it and a closed state in which the valve blocks the airflow in the intake duct, the intake duct and the valve in the closed state delimiting a cavity that opens at the aerodynamic wall.

### BRIEF DESCRIPTION OF THE DRAWINGS

Further features and advantages will become apparent from the following description of the invention, which description is given solely by way of example, with reference to the appended drawings in which:

FIG. 1 is a side view of an aircraft,

FIG. 2 is a longitudinal cross section of an air intake device, illustrating an embodiment of the prior art,

FIG. 3 is a schematic depiction of the air intake device visible in FIG. 2, forming a cavity, and of the airflows circulating over and inside the cavity,

FIG. 4 is a side view of an air intake device forming a cavity, illustrating an embodiment of the invention,

FIG. 5 is a side view of an intake duct, illustrating an embodiment of the invention, a part of the intake duct not being shown in order to make the inside of the intake duct visible,

FIG. 6 is a transverse cross section of a cavity provided with a reduction in passage section, illustrating an embodiment of the invention,

FIG. 7 is a cross section, along the line VII-VII in FIG. 6, of the cavity provided with a reduction in passage section, illustrating an embodiment of the invention.

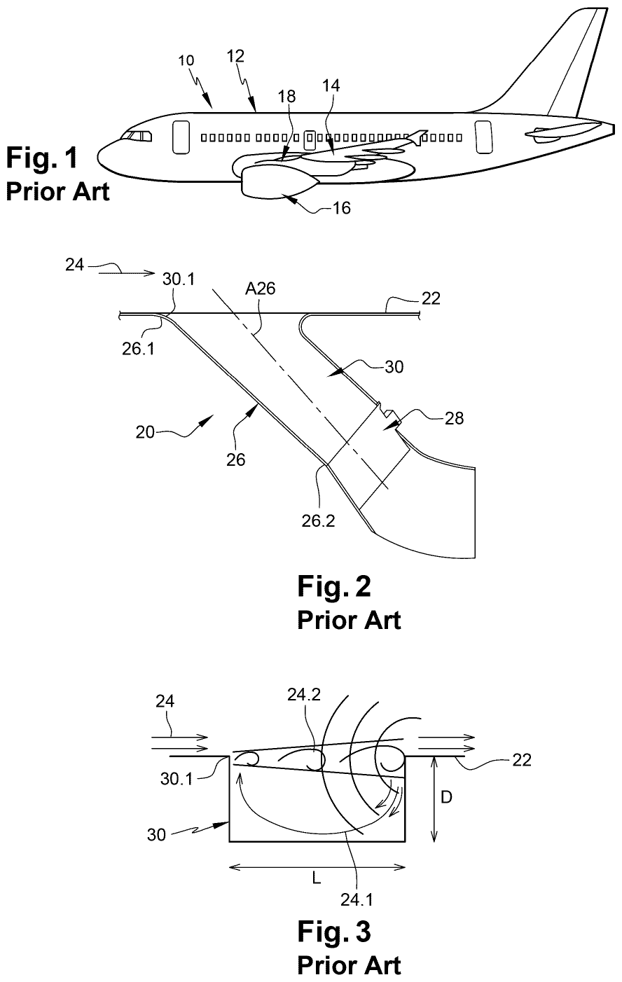

### DETAILED DESCRIPTION OF THE PREFERRED EMBODIMENTS

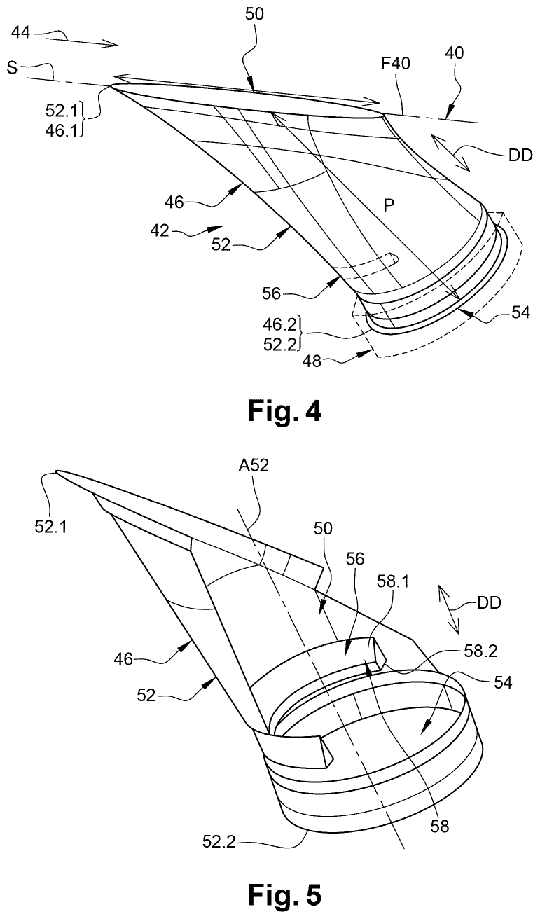

According to an embodiment in FIG. 4, an aircraft comprises at least one aerodynamic wall 40 and at least one air intake device 42.

The aerodynamic wall 40 has an outer face F40 against which an airflow 44 flows in a direction of flow when the aircraft is in flight. The aerodynamic wall may be provided at the fuselage, at a wing, at a propulsion assembly or at a pylon of the aircraft.

The air intake device 42 comprises an intake duct 46, which extends between a first end 46.1 connected to the aerodynamic wall 40 and a second end 46.2, and a valve 48 connected to the second end 46.2 of the intake duct 46 and configured to occupy a permissive state in which the valve 48 allows an airflow channeled by the intake duct 46 to pass through it and a closed state in which the valve 48 blocks the airflow in the intake duct 46.

According to one configuration, the first end 46.1 opens at the aerodynamic wall 40 and has a shape that flares in the direction of the outer face F40 of the aerodynamic wall 40. Thus, the first end 46.1 of the intake duct 46 forms an air inlet of the flush type. According to this configuration, the first end 46.1 of the intake duct 46 is positioned on a reference surface S substantially parallel to the airflow 44, the reference surface S being, apart from the intake duct 46, coincident with the outer face F40 of the aerodynamic wall 40 in contact with the airflow 44. The reference surface S and the outer face F40 may equally be planar or curved.

When the valve 48 is in the closed state, the intake duct 46 and the valve 48 in the closed state form a cavity 50 that opens at the aerodynamic wall 40.

This cavity 50 is delimited by a tubular lateral wall 52 (corresponding to the intake duct 46), which extends between first and second ends 52.1, 52.2, and by a bottom 54 (corresponding to the valve 48 and more particularly to the shutter of the valve) spaced apart from the aerodynamic wall 40 and situated at the second end 52.2 of the tubular lateral wall 52, the first end 52.1 of the tubular lateral wall 52 (corresponding to the first end 46.1 of the intake duct 46) being situated at the outer face F40 of the aerodynamic wall 40. The tubular lateral wall 52 is substantially parallel to a reference direction DD that may be perpendicular or inclined with respect to the reference surface S. By way of indication, the reference direction DD forms an angle of approximately 60° with the reference surface S.

According to one configuration, the tubular lateral wall 52 is cylindrical and has an axis of revolution A52 parallel to the reference direction.

According to one arrangement, the bottom 54 is substantially perpendicular to the reference direction DD.

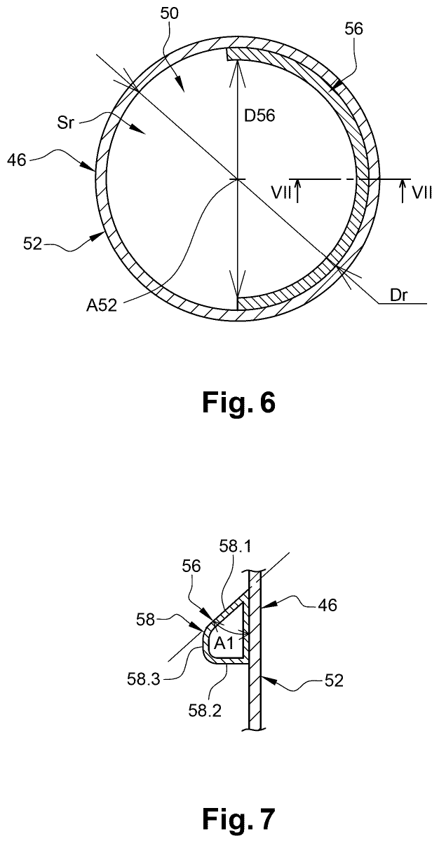

The cavity 50 has a reference passage section Sr corresponding to the section of the tubular lateral wall 52. When the latter is cylindrical, the reference passage section Sr is characterized by a diameter Dr, as illustrated in FIG. 6.

The cavity 50 has a depth P corresponding to the mean distance between the reference surface S and the bottom 54. When the tubular lateral wall 52 is cylindrical, the depth P corresponds to a distance separating a first point of intersection between the axis of revolution A52 and the reference surface S and a second point of intersection between the axis of revolution A52 and the bottom 54.

According to one particular feature of the invention, the cavity 50 comprises at least one reduction in passage section 56 that is spaced apart from the bottom 54 and partial. Partial is understood to mean that the reduction in passage section 56 extends only over a part of the circumference of the tubular lateral wall 52, and not over the entire circumference.

According to one configuration, the reduction in passage section 56 is positioned in a transverse plane perpendicular to the reference direction DD. This transverse plane is situated at a distance from the bottom 54 of the order of 30% of the depth P with a tolerance interval of +/−20% and preferably of +/−5%.

According to one configuration, the reduction in passage section 56 has a passage section of the order of 80% of the reference passage section Sr with a tolerance interval of the order of +/−10%, preferably of +/−5%. When the tubular lateral wall 52 is cylindrical and has a reference diameter Dr, the reduction in passage section 56 has a diameter D56 of the order of 80% of the reference diameter Dr with a tolerance interval of the order of +/−10%, preferably of +/−5%.

According to one arrangement, the reduction in passage section 56 extends over half the circumference of the tubular lateral wall 52 with a tolerance interval of +/−20% and preferably of +/−5%.

According to one arrangement, when the tubular lateral wall 52 is inclined, the reduction in passage section 56 is positioned in an upstream half-space delimited by a median plane, passing through the axis of revolution A52, perpendicular to the direction of flow of the airflow 44. The term upstream refers to the direction of flow of the airflow 44, which flows from upstream to downstream.

According to one embodiment, the reduction in passage section 56 comprises a rib 58, projecting with respect to the tubular lateral wall 52, having a first edge face 58.1 that extends from the tubular lateral wall 52, oriented toward the first end 52.1 of the tubular lateral wall 52, and a second edge face 58.1 that extends from the tubular lateral wall 52, oriented toward the bottom 54.

According to one configuration, the first edge face 58.1 forms an angle A1 with the tubular lateral wall 52 of between 20 and 60°, preferably of between 30 and 40°.

According to one arrangement, the second edge face 58.2 is substantially perpendicular to the tubular lateral wall 52.

According to one embodiment, the rib 58 has an intermediate zone 58.3 interposed between the first and second edge faces 58.1, 58.2 and connecting them. According to one configuration, this intermediate zone 58.3 may be curved.

According to an embodiment visible in FIG. 7, the rib 58 is a hollow roll attached against the tubular lateral wall 52. By way of indication, the rib 58 is made of plastic and fastened against the tubular lateral wall 52 by adhesive bonding or any other means.

The rib 58 could be solid. The fact that the roll is hollow makes it possible to reduce the mass.

The fact that the reduction in passage section 56 is spaced apart from the bottom 54 and partial (not continuous over the entire circumference of the tubular lateral wall 52) makes it possible to obtain a reduction in aerodynamic noise.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft comprising:
at least one aerodynamic wall against which an airflow flows in a direction of flow when the aircraft is in flight, and
a cavity opening at the aerodynamic wall, said cavity being delimited by a tubular lateral wall that extends between first and second ends and by a bottom spaced apart from the aerodynamic wall and situated at the second end of the tubular lateral wall, the first end of the tubular lateral wall being situated at the aerodynamic wall, the cavity having a reference passage section and a depth, the tubular lateral wall being parallel to a reference direction and having a circumference;
wherein the cavity comprises at least one reduction in passage section, spaced apart from the bottom, which extends only over a part of the circumference of the tubular lateral wall.

2. The aircraft as claimed in claim 1, wherein the reduction in passage section extends over half the circumference of the tubular lateral wall with a tolerance interval of +/−20%.

3. The aircraft as claimed in claim 2, wherein the tolerance interval is +/−5%.

4. The aircraft as claimed in claim 2, wherein the reduction in passage section is positioned in an upstream half-space delimited by a median plane perpendicular to the direction of flow of the airflow.

5. The aircraft as claimed in claim 1, wherein the reduction in passage section is positioned in a transverse plane perpendicular to the reference direction.

6. The aircraft as claimed in claim 5, wherein the transverse plane is situated at a distance from the bottom of an order of 30% of the depth of the cavity with a tolerance interval of +/−20%.

7. The aircraft as claimed in claim 6, wherein the tolerance interval is +/−5%.

8. The aircraft as claimed in claim 1, wherein the reduction in passage section has a passage section of an order of 80% of the reference passage section with a tolerance interval of an order of +/−10%.

9. The aircraft as claimed in claim 8, wherein the tolerance interval is +/−5%.

10. The aircraft as claimed in claim 8, wherein the tubular lateral wall is cylindrical and has a reference diameter and wherein the reduction in passage section has a diameter of an order of 80% of the reference diameter with a tolerance interval of an order of +/−10%.

11. The aircraft as claimed in claim 10, wherein the tolerance interval is +/−5%.

12. The aircraft as claimed in claim 1, wherein the reduction in passage section comprises a rib, projecting with respect to the tubular lateral wall, having a first edge face that extends from the tubular lateral wall, oriented toward the first end of the tubular lateral wall, and a second edge face that extends from the tubular lateral wall, oriented toward the bottom.

13. The aircraft as claimed in claim 12, wherein the first edge face forms an angle with the tubular lateral wall of between 20 and 60°.

14. The aircraft as claimed in claim 13, wherein the angled is between 30 and 40°.

15. The aircraft as claimed in claim 12, wherein the second edge face is substantially perpendicular to the tubular lateral wall.

16. The aircraft as claimed in claim 12, wherein the rib is a hollow roll attached against the tubular lateral wall.

17. The aircraft as claimed in claim 1, wherein the aircraft comprises:
an air intake device having an intake duct, which extends between a first end connected to the aerodynamic wall and a second end, and
a valve connected to the second end of the intake duct and configured to occupy a permissive state in which the valve allows an airflow channeled by the intake duct to pass through it and a closed state in which the valve blocks the airflow in the intake duct, the intake duct and the valve in the closed state delimiting a cavity that opens at the aerodynamic wall.
